(19) United States
(12) Patent Application Publication
(10) Pub. No.: US 2010/0013929 A1
(43) Pub. Date: Jan. 21, 2010

(54) Event Data Recorder with Lane Departure Warning Function

(76) Inventors: Chih-Wei LO, ChungHo City (TW); Shih-Ho Lin, Chung-Ho City (TW); Hui-Chen Wei, Chung-Ho City (TW)

Correspondence Address: TROXELL LAW OFFICE PLLC, SUITE 1404, 5205 LEESBURG PIKE, FALLS CHURCH, VA, 22041, US

(21) Appl. No.: 12/176,340

(22) Filed: Jul. 19, 2008

(51) Int. Cl. H04N 7/18; B60Q 1/00

(52) U.S. Cl. 348/148; 340/435; 348/E07.085

(57) ABSTRACT

An event data recorder with a function of lane departure warning is revealed. The device combines a LDWS (Lane Departure Warning System) with a EDR (Event Data Recorder). The LDWS uses at least one image sensor to capture road images that are sent to a DSP for being processed and identified. The EDR uses image/audio sensors to capture images in front of the car and/or sounds of surrounding. The data is sent to a recorder and is compressed for being saved into a storage device. Thus the device not only has both functions of the EDR as well as the LDWS, it further records vehicle signals, numbers of lane departure issues, and surrounding conditions of car accidents for finding out human or vehicle faults that cause the accident. Therefore, functions and efficiency of the EDR are improved.

### BACKGROUND OF THE INVENTION

The present invention relates to an EDR (Event Data Recorder), especially to an EDR that combines a LDWS (Lane Departure Warning System) with an EDR so as to record vehicle signals, numbers of lane departure issues, and surrounding conditions of car accidents for clarifying factors of accidents such as human or vehicles faults

Cars are popular transportation vehicles. In recent years, the different accessories of electronic equipment such as GPS (global positioning system), LDWS (Lane Departure Warning System) or EDR (Event Data Recorder) are disposed on cars due to various requirements of users. As shown in FIG. 1, a LDWS 1 includes an image capture device 10 such as a lens disposed in front of the car, facing the road and used to track lane images. Then the captured image is input into an electronic control unit 11 via a video input unit 12 transmission to DSP (Digital Signal Processing) unit 13 and combines a memory unit 14 for being processed and identified. Moreover, in combination with vehicle signal's interface unit 15 to input to judge whether there is a dangerous driving behavior. For example, it is took vehicle signals from the driver did not turn on a left/right turn signal while the image shows that the car is out of the lane, that shall be audio unit 16 and/or video unit 17 issue audiovisual warnings to the driver. Refer to FIG. 2, an EDR 2 used to image capture device 20 and/or sound capture device (such as microphone) 21 which installed inside/ outside the car to capture images in front of the car and/or sounds of surround the car. The image/sound is input an ECU (electronic control unit) 22 of the EDR 2. The ECU 22 consists of a video input unit 23, a memory unit 27 and an image compression unit 26 for processing the images, an analog/digit (A/D) unit 24 and an audio codec unit 25 for processing the sounds, a storage interface 28 such as SDCI and a storage unit 29 for saving data. After being compressed, all images and sounds data are saved into the storage unit 29. Even after the system power failure, the images and/or sounds are still recording for seconds, so that the data can be retrieved and presented as evidence after car accidents. However, the above LDWS 1 and the EDR 2 are installed and used respectively.

There are increasing numbers of terrorist attacks in recent years, so that American and European countries have paid more attention on security systems that are effective on stopping crime and collecting evidence. More security systems have been developed. A MDVR (Mobile Digital Video Recorder) is a mini-security system disposed on vehicles and used broadly on travel or school buses. Moreover, the MDVR is combined with other systems to have multiple functions such as advertising, description, warning, displaying, internet and global positioning, so that it's not only a security device but also a service device. Generally, the MDVR uses a DVR (Digital Video Recorder) connected with various monitoring devices such as mini image sensors or audio sensors (mini-microphones), back-view mirror display systems, mobile displays, speakers, remote controllers and GPS receivers. Furthermore, one MDVR basically includes at least one storage devices for recording dynamic video and/or audio data in digital way. By real time recording, the data detected is saved into the storage unit for long term storage or data searching. Moreover, the cost and space of storage units are saved, due to well-development of compression techniques of digital images and high compression ratio of DVR (Digital Video Recorder), it is suitable for long-term and continuous recording. Thus, the EDR of the present invention has similar structure and function of the above EDR 2 or MDVR and it can be used as MDVR after being improved. Thus the so-called EDR in the present invention includes MDVR.

However, above mentioned LDWS 1 and EDR 2 (or MDVR) exist respectively. A conventional LDWS 1 can only warn a driver when the vehicle begins to move out of the lane, without car event data recording function (digital image recording). As to the EDR 2 (or MDVR), it can have functions such as advertising, description, warning, displaying, internet and global positioning, except lane departure warning effect. Thus once the user want to have both lane departure warning effect and event data recording function, two devices—LDWS 1 and EDR 2 are installed respectively. The image capture devices 10, 20 in FIG. 1, FIG. 2 are arranged respectively. Due to limited space in the vehicle, it trouble and inconvenient to install the devices respectively. Moreover, the image capture devices 10, 20 have similar structure yet require respective installation. Thus both the manufacturing and the assembling cost are increased and that lead to negative effect on mass-production and prevalence of the LDWS 1 as well as the EDR 2. Especially the LDWS 1 that warns the driver when the car is out of the line has no event data recording function. When a dangerous vehicle driving behavior is checked and an audio/video warning is issued, it is difficult to learn causes of car accidents without any recording of the dangerous vehicle driving behavior according to data of the EDR 2 once the car accident happens. This cause trouble and confusion in investigation of responsibility in accidents and claiming compensation. Therefore, the efficiency of the LDWS 1 as well as the EDR 2 is reduced.

### SUMMARY OF THE INVENTION

Therefore it is a primary object of the present invention to provide an EDR (Event Data Recorder) with a function of LDWS (Lane Departure Warning System) that combines a LDWS with an EDR. The device not only has respective function of the LDWS as well as the EDR, it further records vehicle signals, numbers of lane departure issues, and surrounding conditions of car accidents and saves them into a storage device. This is helpful in clarifying factors of car accidents such as human or vehicles faults so as to improve efficiency of the EDR and prevent trouble of respective installation of the LDWS and the EDR.

It is another object of the present invention to provide an EDR (Event Data Recorder) with a function of LDWS (Lane Departure Warning System). The composition in both EDR and LDWS with similar functions such as the image capture device is simplified into one member so as to simplifying assembling of the device, reducing assembling inconvenience, cost and space occupied. The manufacturing cost is also down. This is beneficial to mass production and prevalence of the LDWS and the EDR.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing structure of a conventional LDWS (Lane Departure Warning System);

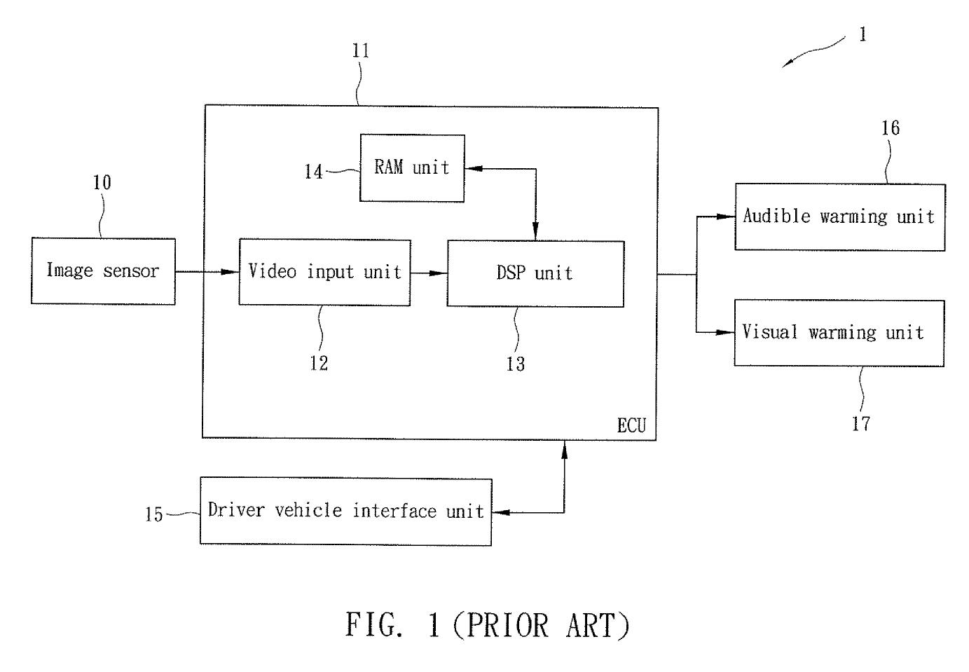

FIG. 2 is a block diagram showing structure of a conventional EDR (Event Data Recorder);

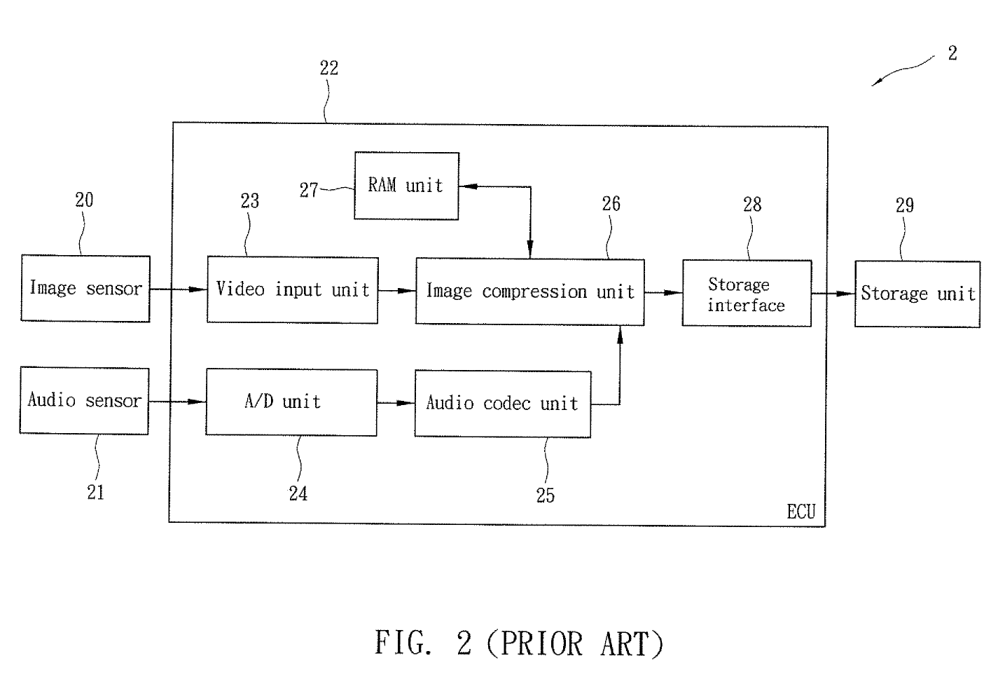

FIG. 3 is a block diagram showing structure of an embodiment according to the present invention.

### DETAILED DESCRIPTION OF THE PREFERRED EMBODIMENT

An embodiment of the present invention combines a LDWS and an EDR (or a MDVR). The structure or function of the LDWS or the EDR can be changed or modified. There is no restriction on number and structure of the image sensors and the audio sensors such as microphone. The image sensor can be a CMOS (Complementary Metal-Oxide-Semiconductor), a high-quality CCD (Charge Coupled Device) or an image capture device which has the same functions of the image sensors of LDWS/EDR. An ECU can be an integrated member with more other functions such as advertising displaying or connecting with various monitoring devices such as mini-image sensor, audio sensor, back-view mirror display systems, mobile displays, speakers, remote controllers and GPS receivers. There is also no limit on the way of image compression and storage device. The SD card or the hard disc can be used as storage device.

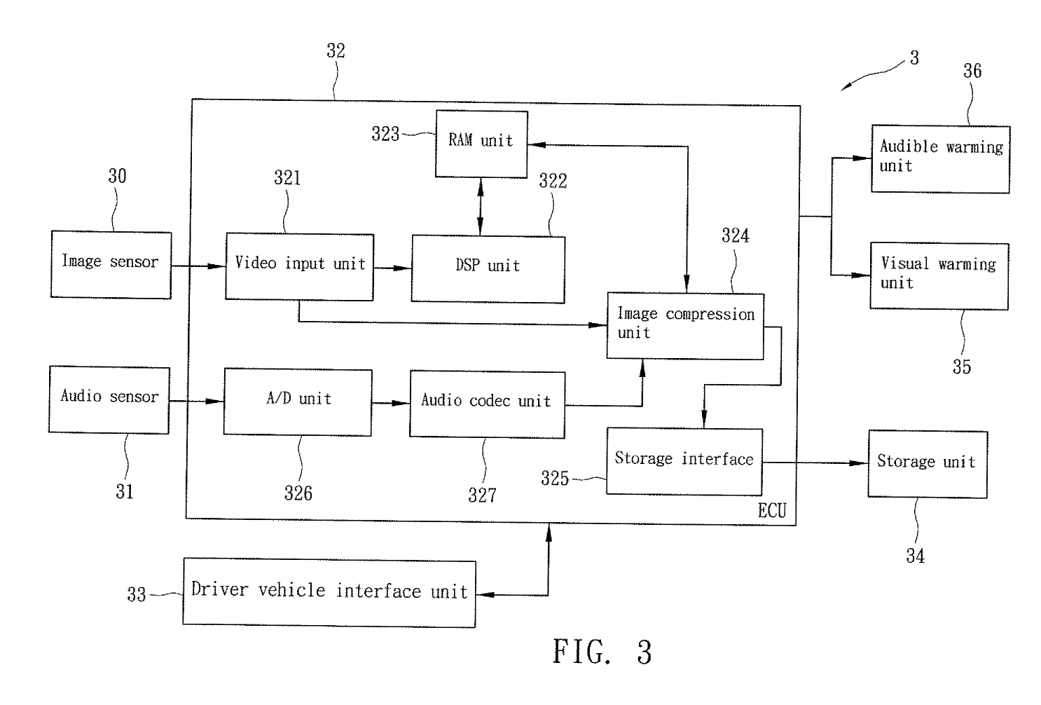

Refer to FIG. 3, an event data recorder (EDR) 3 with a function of LDWS (lane departure warning system) consists of an image sensor 30 and/or an audio sensor 31 such as microphone, an electronic control unit (ECU) 32, a driver vehicle interface 33, at least one storage unit 34 such as SD card or hard disc, and/or an audible warning unit 36(35), and/or a visual warning unit 35(36). The ECU 32 further comprises a video input unit 321, a digital signal processor (DSP) 322, a memory unit 323 such as a RAM (Random Access Memory), an image compression unit 324, a storage unit interface 325 such as SDCI, and/or an analog/digit (A/D) unit 326, and/or an audio codec unit 327.

The image sensor 30 is disposed inside the car for capturing images in front of the car. The images shot are input into ECU (Electronic Control Unit) and through the video input unit 321, then they are divided into two ways for running the function of the EDR and the function of the LDWS. The images are sent to the DSP (digital signal processor) 322 and the memory unit 323 for being processed and identified. Then in combination with the vehicle signals from the driver vehicle interface 33, whether there is a dangerous vehicle driving behavior is checked. Once the result is yes, for example, it is learned from vehicle signals that the driver did not turn on any turn signal but the road image shows that the car is out of the lane, the audible warning unit 36 and/or the a visual warning unit 35 issue audiovisual warnings to the driver so as to achieve lane departure warning effect of the LDWS. On the other hand, the images data passes through the image compression unit 324, together with the memory unit 323, and the storage unit interface 325 such as SDCI and then being saved into the storage unit 34 such as SD card. Even after several seconds of the system power failure, the images/sounds are continuingly recorded so that the recorded data can be retrieved as evidence while car accidents happen and this achieves the function of the EDR.

The audio sensor 31 such as mini-microphone is disposed on the inside or outside the car for synchronously recording sounds of surrounding the car, used in combination with the image sensor 30.

Then the sound is input into the ECU 32, passing through the A/D unit 326, the audio codec unit 327, the image compression unit 324, the memory unit 323, the storage unit interface 325 and then saved into the storage unit 34 such as SD card. Moreover, even when the system has power failure, the recording of the images/sounds keeps going for several seconds. While a car accident happening, the recorded data is retrieved as evidence. The images from the image sensor 30 are synchronously also saved into the storage unit 34. Thus the function of the EDR is achieved.

The Event Data Recorder having a lane departure warning function 3 of the present invention has not only functions of the LDWS and EDR but also records vehicle signals, numbers of lane departure issues, and surrounding conditions of car accidents for saving into the storage device. Thus the data can be retrieved while a car accident happening to clarify causes of the accident such as human faults or vehicle faults. Therefore, functions and efficiency of the EDR are enhanced. Moreover, the same member of the LDWS and the EDR such as the image sensor 30 can be shared with each other. Or a housing (not shown in figure) is used to accommodate related members even the ECU 32 of the LDWS as well as the EDR so as to simplify the assembling and installation. The trouble and cost of respective installation of the LDWS and the EDR can be avoided and reduced. The reduced cost has positive effect on mass production and prevalence of EDR 3 with the lane departure warning function of the present invention.

The circuit of the LDWS and the EDR of the present invention can be designed and integrated.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An event data recorder having a lane departure warning function of a LDWS (Lane Departure Warning System) comprising at least one image sensor, an electronic control unit (ECU), a driver vehicle interface, at least one storage unit, and a warning unit; wherein
the image sensor is to capture images in front of a vehicle and input the shot images into the electronic control unit;
the electronic control unit having a video input unit, a digital signal processor (DSP), a memory unit, an image compression unit, a storage unit interface, an analog/digit (AID) unit, and an audio codec unit;
wherein, after the images from the image sensor being input into the video input unit, the images are sent to the digital signal processor and the memory unit for being processed and identified and at the same time by means of the vehicle signals from the driver vehicle interface, whether there is a dangerous vehicle driving behavior is checked; once a result of checking is yes, the warning unit issues audiovisual warnings to a driver; on the other hand, the images also pass through the image compression unit and the memory unit, the storage unit interface and then being saved into the storage unit;
wherein the electronic control unit synchronously records vehicle signals, numbers of lane departure issues, and surrounding conditions of car accident and saved them into the storage unit.

2. The device as claimed in claim 1, wherein the event data recorder having a lane departure warning function of a LDWS further comprising at least one audio sensor that is used in combination with the image sensor to synchronously capturing sounds of surrounding the vehicle and inputting the captured sounds into the electronic control unit.

3. The device as claimed in claim 2, wherein the electronic control unit further comprising an analog/digit (A/D) unit and an audio codec unit while after the sounds captured by the audio sensor input into the electronic control unit, data of the sounds passes through the analog/digit (A/D) unit, the audio codec unit, then the image compression unit together with the memory unit, the storage unit interface and then being saved into the storage unit.

4. The device as claimed in claim 1, wherein the storage unit is a SD card.

5. The device as claimed in claim 1, wherein the image sensor of the device is used to capture images in front of the car.

6. The device as claimed in claim 1, wherein the warning unit is an audible warning unit or a visual warning unit.
